(19) United States
(12) Patent Application Publication
(10) Pub. No.: US 2015/0373454 A1
(43) Pub. Date: Dec. 24, 2015

(54) Sound-Emitting Device and Sound-Emitting Method

(71) Applicant: YAMAHA CORPORATION, Shitzuoka (JP)

(72) Inventor: Hiroomi SHIDOJI, Hamamatsu-shi, Shizuoka (JP)

(21) Appl. No.: 14/764,242

(22) PCT Filed: Jan. 27, 2014
(86) PCT No.: PCT/JP2014/051729

§ 371 Date: Jul. 29, 2015

(30) Foreign Application Priority Data
Jan. 30, 2013 (JP) 2013-015487

(51) Int. Cl. H04R 3/04; H04R 5/04; H04R 1/40; H04R 5/02; G10L 21/003; G10L 21/013

(52) U.S. Cl. CPC H04R 3/04; G10L 21/003; G10L 21/013; H04R 1/403; H04R 5/02; H04R 5/04; H04R 2420/01; H04R 2430/03; H04R 2499/15

(57) ABSTRACT

A sound-emitting device includes a high-frequency extractor, adapted to accept input of a sound signal, extract high-frequency components of sound and output a high-frequency sound signal, a low-frequency extractor, adapted to accept input of the sound signal, extract low-frequency components of sound and output a low-frequency sound signal, a delay processor, adapted to delay low-frequency components of the low-frequency sound signal within a time range not causing an echo, relative to the high-frequency sound signal, to thereby output a delayed low-frequency sound signal, and a sound emitter, adapted to emit sound based on the high-frequency sound signal and the delayed low-frequency sound signal.

### TECHNICAL FIELD

The present invention relates to a sound-emitting device and a sound-emitting method each used integrally with an image display device.

### BACKGROUND ART

A sound-emitting device has been known which is disposed in the vicinity of an image display device (television, for example) and (amplifies and) emits a sound signal of contents to be reproduced by the image display device (see Patent Literature 1).

### CITATION LIST

### Patent Literature

Patent Literature 1: JP-A-2012-195800

### SUMMARY OF INVENTION

### Technical Problem

In a sound-emitting device, generally, a sound image is localized at the position of a speaker from which sound is emitted. Thus, in a case where the sound-emitting device is installed at a lower position than a horizontal line which passes the center point of an image screen of an image display device where an image is displayed, a sound image is formed below the horizontal line of the image screen. As a result, a viewer feels a sense of incongruity because the position of a sound image of sound emitted from the sound-emitting device does not coincide with the height of the image screen to be watched.

In view of this, the present invention provides a sound-emitting device and a sound-emitting method each of which forms a sound image with a feeling of realistic sensation as if sound is emitted from the image screen of an image display device.

### Solution to Problem

A sound-emitting device according to an aspect of the present invention includes: a high-frequency extractor, adapted to accept input of a sound signal, extract high-frequency components of sound and output a high-frequency sound signal; a low-frequency extractor, adapted to accept input of the sound signal, extract low-frequency components of sound and output a low-frequency sound signal; a delay processor, adapted to delay low-frequency components of the low-frequency sound signal within a time range not causing an echo, relative to the high-frequency sound signal, to thereby output a delayed low-frequency sound signal; and a sound emitter, adapted to emit sound based on the high-frequency sound signal and the delayed low-frequency sound signal.

A sound signal is divided into a sound signal of high-frequency components extracted by the high-frequency extractor and a sound signal of low-frequency components extracted by the low-frequency extractor, and these sound signals thus divided are outputted. The low-frequency sound signal is delayed by a predetermined time (5 ms, for example) by the delay processor and outputted. Thus, sound of low-frequency components is delayed by the predetermined time (5 ms, for example) and emitted. That is, sound of high-frequency components is emitted earlier by 5 ms than sound of low-frequency components. As a result, a viewer hears sound of high-frequency components earlier than sound of low-frequency components. When a person hears sound of high-frequency components, the person feels that the sound is heard from a higher position than an actual sound source position. Further, when low-frequency components is delayed and emitted as sound, a sound image of high-frequency components becomes clear and a sense of localization can be obtained. As a consequence, a viewer perceives that a sound image locates at a higher position than the actual position of the sound-emitting device.

In a case where an arrive time difference between sounds from two sound sources is within a predetermine range and a difference of volumes between the two sounds is within a predetermine range, human beings perceive a sound image in a direction of sound reached a listener earlier (Haas effect). Thus, even if sound of low-frequency components is delayed and emitted, a viewer perceives a sound image only in a direction of sound of high-frequency components due to the Haas effect. That is, a viewer perceives that a sound image locates at a higher position than the actual position of the sound-emitting device.

As described above, the sound-emitting device according to the aspect of the present invention emits sound of high-frequency components earlier than sound of low-frequency component to thereby move a sound image upward. As a result, a user does not feel a sense of incongruity due to inconsistency between the height of an image screen and the height of a sound image.

Incidentally, the predetermined delay time imparted to low-frequency components is not limited to 5 ms. The delay time may be a time period of a degree (5 ms to 40 ms, for example) capable of obtaining the Hass effect. In other words, this delay time between sound of delayed low-frequency components and sound of high-frequency components not being delayed is within a range not causing an echo. As the sound-emitting device according to the aspect of the present invention emits sound which is perceived as single sound by a viewer, influence on sound quality can be suppressed to the minimum.

A sound signal inputted to the sound-emitting device according to the aspect of the present invention is not limited to a sound signal outputted from a content reproducing device. For example, the sound-emitting device according to the aspect of the present invention may receive a sound signal contained in television broadcast contents.

The sound-emitting device may adopt a mode in which the device further includes an adder, adapted to add the delayed low-frequency sound signal with the high-frequency sound signal to output an added sound signal, and the sound emitter emits sound based on the added sound signal.

A sound signal of high-frequency components and a sound signal of low-frequency components subjected to a delay processing are added so as to form a single sound signal by the adder. In this case, the sound-emitting device can emit sound of high-frequency components earlier than sound of low-frequency components even if the device has only a single speaker unit.

Cutoff frequencies of the high-frequency extractor and the low-frequency extractor may be set to frequencies in a vicinity of formant frequencies of vowels, respectively.

When these cutoff frequencies are set to frequencies in the vicinity of the formant frequencies, respectively, a raising effect of a sound image can be enhanced.

Human beings have auditory characteristics of likely being aware of change of sound in the formant frequency. Thus, in a case where the cutoff frequency is set so as to be slightly separated from the formant frequency, the raising effect of a sound image can also be attained while reducing influence on sound quality.

The sound-emitting device can adopt a mode in which the device further includes a pitch changer which is provided at a front or rear stage of the low-frequency extractor and is adapted to change a pitch of the inputted sound signal.

The pitch changer shifts a frequency band of sound to a high frequency side. As a result, low-frequency components of sound reduce. Thus, as a viewer hears sound which low-frequency components is reduced, the viewer unlikely perceives a sound image based on sound of low-frequency components as compared with sound of high-frequency components. As a consequence, a viewer likely perceives a sound image of sound of high-frequency components emitted prior to sound of low-frequency components, and hence perceives that a sound image locates at a higher position than the actual position of the sound-emitting device.

The pitch changer may change a pitch of a sound signal of a vowel section of the inputted sound signal.

In a general sound signal, a vowel portion of sound largely influences perception of a sound image as compared with a consonant portion of sound. Thus, the sound-emitting device changes a pitch of only a vowel section of a sound signal, thereby further emphasizing the raising effect of a sound image.

The sound-emitting device may further include a reverberation imparting unit which is provided at a front or rear stage of the low-frequency extractor and is adapted to impart reverberation components to the inputted sound signal.

As reverberation components is imparted to low-frequency components of a sound signal extracted by the low-frequency extractor, a sense of localization of a sound image based on the low-frequency components degrades. As a result, a viewer likely perceives a sound image formed by sound of high-frequency components, and the raising effect of a sound image is enhanced. Further, in a case where a sense of localization of a sound image based on low-frequency components degrades, the grasp of a position of a sound image becomes largely depending on visual sense. As a consequence, a person likely perceives that a sound image localizes at a position of the image screen.

A sound-emitting method according to an aspect of the present invention includes: extracting high-frequency components of an inputted sound signal and outputting a high-frequency sound signal; extracting low-frequency components of the sound signal and outputting a low-frequency sound signal; delaying low-frequency components of the low-frequency sound signal within a time range not causing an echo relative to the high-frequency sound signal and outputting a delayed low-frequency sound signal; and emitting sound based on the high-frequency sound signal and the delayed low-frequency sound signal.

### Advantageous Effects of Invention

According to the aspects of the present invention, sounds for localizing a sound image at the upper position of a speaker can be outputted.

### BRIEF DESCRIPTION OF DRAWINGS

FIG. 1A is a diagram showing install environment of a center speaker 1.

FIG. 1B is a block diagram of a signal processor 10.

FIG. 2A is a diagram showing install environment of a bar speaker 4 having plural speaker units.

FIG. 2B is a block diagram of a signal processor 40.

FIG. 3A is a diagram showing a bar speaker 4A or 4B according to a modified example of the bar speaker 4.

FIG. 3B is a block diagram showing a part of a configuration relating to a signal processing of the bar speaker 4A.

FIG. 3C is a block diagram showing a part of a configuration relating to a signal processing of the bar speaker 4B.

FIG. 4 is a block diagram showing a part of a configuration relating to a signal processing of a bar speaker 4C according to a modified example of the bar speaker 4.

FIG. 5A is a diagram showing install environment of a stereo speaker set 5.

FIG. 5B is a block diagram of a signal processor 10L and a signal processor 10R.

FIG. 6A is a block diagram of the signal processor 10L and a signal processor 10R1 of a stereo speaker set 5A.

FIG. 6B is a block diagram of a signal processor 10L2 and a signal processor 10R2 of a stereo speaker set 5B.

FIG. 7 is a block diagram of a signal processor 10A according to a modified example 1 of the signal processor 10.

FIG. 8A is a block diagram of a signal processor 10B according to a modified example 2 of the signal processor 10.

FIG. 8B is a schematic diagram of a sound signal having a vowel section.

FIG. 8C is a diagram showing an example of shortening a part of a vowel section.

FIG. 9 is a schematic diagram of a sound signal in which a part of a consonant section is deleted.

FIG. 10A is a block diagram of a signal processor 10C according to a modified example 3 of the signal processor 10.

FIG. 10B is a block diagram of a vowel emphasizer 19 within the signal processor 10C.

FIG. 11 is a block diagram of a consonant attenuator 19A according to a modified example of the vowel emphasizer 19.

### DESCRIPTION OF EMBODIMENTS

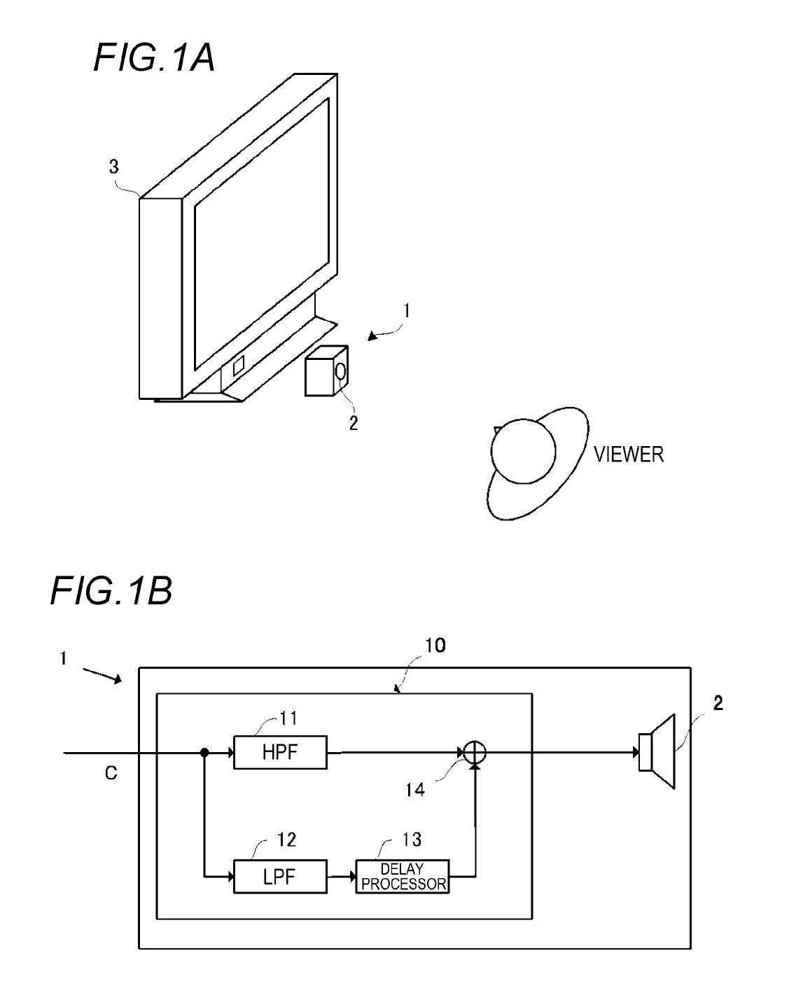

FIG. 1A is a diagram showing install environment of a center speaker 1 according to an embodiment. As shown in FIG. 1A, the center speaker 1 is installed at a portion in front of a television 3 and lower than an image screen of the television 3. In the center speaker 1, sound is emitted from a speaker 2 provided at the front face of a casing based on a sound signal containing a center channel of contents.

The sound-emitting device according to the present invention receives a sound signal of contents of television broadcasting or contents reproduced by a BD (Blu-Ray Disc (trademark)) player. An image signal of contents is inputted to the television 3 and displayed thereon.

FIG. 1B is a block diagram showing a signal processor 10 which is a part of a configuration relating to a signal processing of the center speaker 1. The signal processor 10 includes an HPF 11, an LPF 12, a delay processor 13 and an adder 14.

The HPF 11 is a high pass filter which passes high-frequency components (1 kHz or more, for example) of an inputted sound signal. The LPF 12 is a low pass filter which passes low-frequency components (less than 1 kHz, for example) of an inputted sound signal. The delay processor 13 delays a sound signal of low-frequency components passed through the LPF 12 by a predetermined time (5 ms, for example). A sound signal passed through the HPF 11 is added to a sound signal outputted from the delay processor 13 by the adder 14. Then, a sound signal outputted from the adder 14 is emitted as sound from the speaker 2. That is, sound of high-frequency components is emitted earlier than sound of low-frequency components from the speaker 2.

Human beings have characteristics that they perceive a sound image at an upper side (higher position) than the position of a sound source (speaker 2) from which sound is emitted actually, in a case of listening to sound in which particular frequency components (low-frequency components) is deleted therefrom (attenuated) and only high-frequency components remains (or a level of high-frequency components is quite high as compared with a level of low-frequency components). The present invention utilizes the characteristics in a manner that a signal of high-frequency components filtered through the high pass filter is outputted to thereby localize a sound image at an upper side than the position of an actual sound source (speaker 2).

On the other hand, low-frequency components is delayed relative to high-frequency components and then emitted as sound so as to hardly influence the localization of a sound image.

In a case where an arrive time difference between sounds from two sound sources is within a predetermine range and a difference of volumes between the two sounds is within a predetermine range, human beings perceive a sound image in a direction of sound reached a listener earlier (Haas effect). In a case where frequency characteristics of two sound sources differs, for example, even if sound of only high-frequency components and sound of only low-frequency components is emitted, the Haas effect can be attained. Thus, even if sound of low-frequency components is delayed and emitted, a viewer perceives a sound image in a direction of sound of high-frequency components due to the Haas effect. That is, a viewer perceives that a sound image locates at a higher position than the actual position of the speaker 2.

The center speaker 1 is simply configured of only one speaker 2. Thus, the center speaker 1 does not require a complicated procedure of arranging plural speakers.

Incidentally, the delay time of low-frequency components is not limited to 5 ms. The delay time may be a time period of a degree (from 5 ms to 40 ms, for example) capable of attaining the Haas effect. In other words, a range of the delay time is a time range not causing an echo between sound of low-frequency components having been delayed and sound of high-frequency components not being delayed. By so doing, as the center speaker 1 emits sound perceived as single sound by a viewer, influence on sound quality can be suppressed to the minimum.

A cutoff frequency of the HPF 11 is not limited to 1 kHz but may be set in the vicinity of formant frequencies of vowels. For example, the cutoff frequency may be set to be slightly higher than first formant frequencies of respective vowels so that frequency components higher than second formant frequencies of respective vowels is extracted. Alternatively, the cutoff frequency may be set to be slightly lower than the first formant frequencies of the vowels so that frequency components higher than the first formant frequencies of the vowels is extracted.

Human beings have auditory characteristics of likely being aware of change of sound in the formant frequencies of vowels. Thus, in a case of putting importance on sound quality, the cutoff frequency is desirably set so as to be further separated from the formant frequencies.

The speaker of the sound-emitting device according to the present invention is not limited to one having a single speaker unit but may be one having plural speaker units so long as the speaker is installed at the lower side with respect to the television 3.

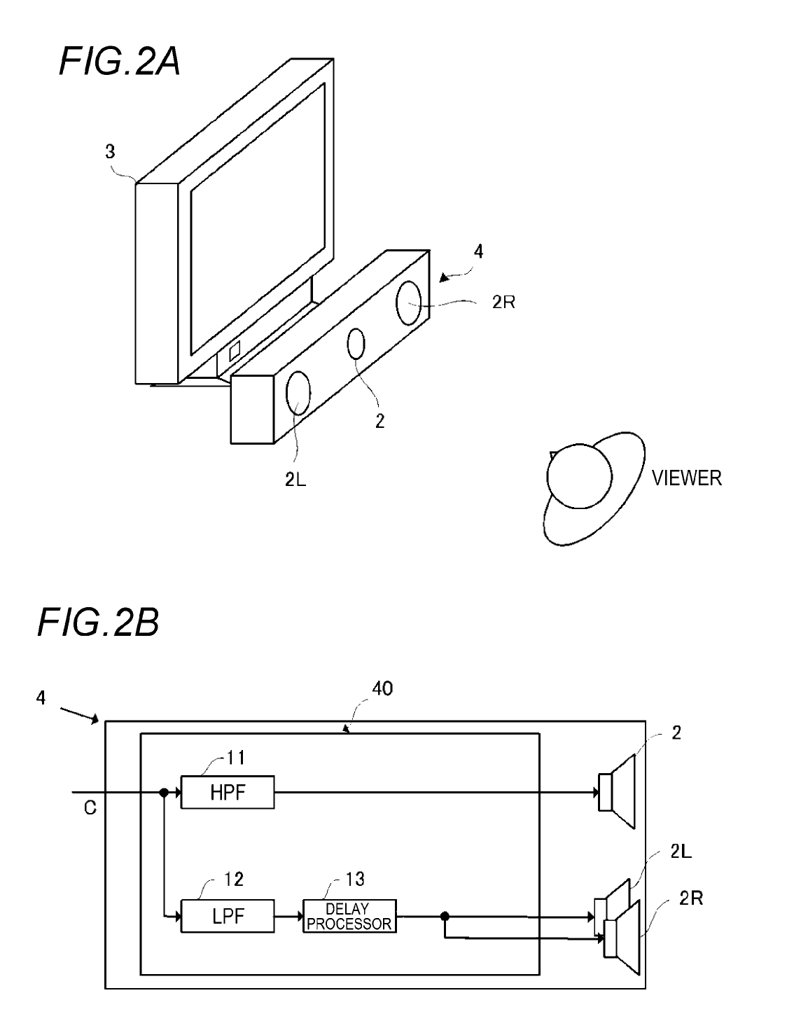

FIG. 2A is a diagram showing install environment of a bar speaker 4 having plural speaker units. The bar speaker 4 has a rectangular parallelepiped shape which is long in the left-right direction and short in the height direction. The bar speaker 4 emits sound from a woofer 2L, a woofer 2R and a speaker 2 provided at the front face of a casing, based on a sound signal containing a center channel.

The speaker 2 is provided at the center of the front face of the casing of the bar speaker 4. The woofer 2L is provided at the left side of the front face of the casing in a case of viewing the bar speaker 4 from a viewer. The woofer 2R is provided at the right side of the front face of the casing in a case of viewing the bar speaker 4 from a viewer.

FIG. 2B is a block diagram showing a signal processor 40 of the bar speaker 4. Explanation will be omitted as to constitutional portions overlapping with those of the signal processor 10 shown in FIG. 1B.

A sound signal passed through the HPF 11 is emitted from the speaker 2 as sound. That is, the speaker 2 emits high-frequency components of a center channel as sound. A sound signal passed through the delay processor 13 is emitted from the woofer 2L and the woofer 2R as sound. That is, each of the woofer 2L and the woofer 2R emits sound of delayed low-frequency components of a center channel.

The woofer 2L and the woofer 2R locate at the left side and right side of the bar speaker 4, respectively. In other words, a viewer listens to sound of a center channel from the left side and the right side. As a result, a sense of localization of a sound image based on the low-frequency components degrades as compared with a case of listening using only the speaker 2. Thus, a viewer unlikely feels a sound image at a height substantially same as the height of the bar speaker 4, and likely recognizes a sound image at a high position formed by sound of high-frequency components. Further, a viewer tends to rely on auditory sense in terms of mental auditory characteristics when a sound image becomes unclear. A viewer feels that a sound image presents in a watching direction when visual information is used in preference to auditory information. Thus, a viewer likely feels that sound is heard from the image screen of the television 3.

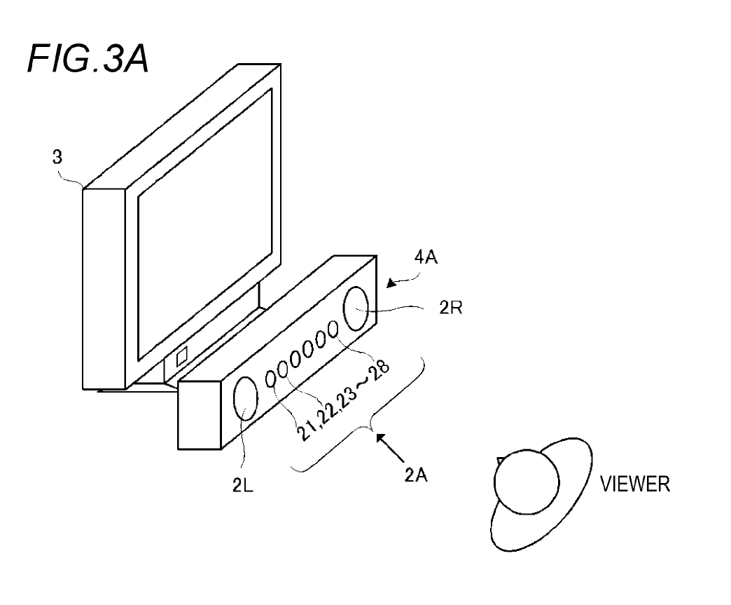

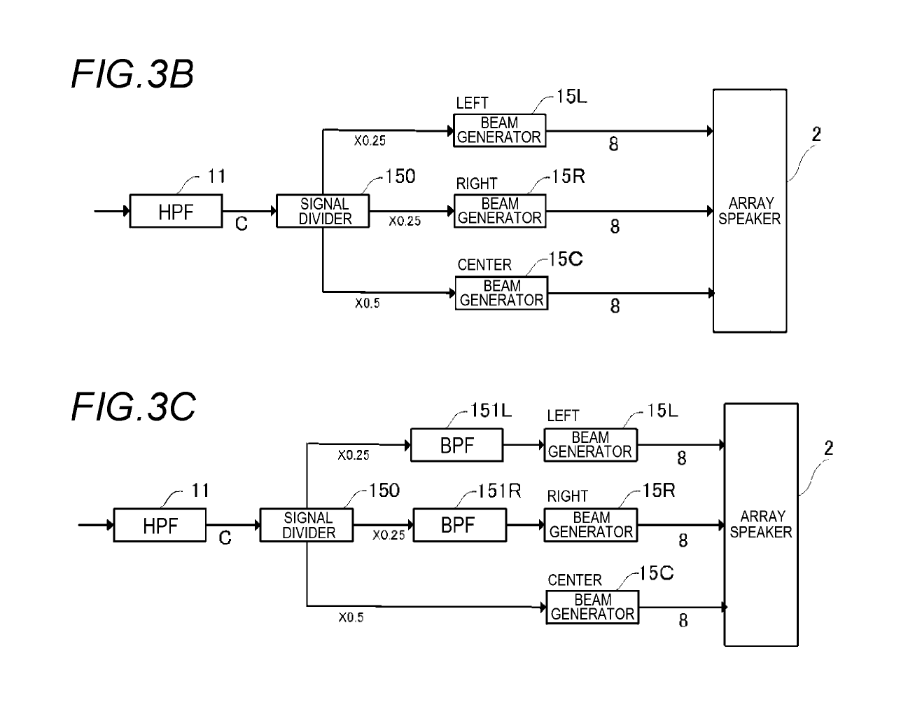

Next, FIG. 3A is a diagram showing install environment of a bar speaker 4A according to a modified example of the bar speaker 4. The bar speaker 4A emits sound of high-frequency components using an array speaker 2A.

As shown in FIG. 3A, the array speaker 2A is configured of speaker units 21 to 28 disposed in an array fashion. The speaker units 21 to 28 are arranged in one row along the longitudinal direction of a casing of the bar speaker 4A.

FIG. 3B is a block diagram showing a part of a configuration for generating a sound signal to be outputted to the array speaker 2A.

A sound signal of a center channel outputted from the HPF 11 is inputted to a signal divider 150. The signal divider 150 divides a sound signal inputted thereto at a predetermined ratio and outputs to a beam generator 15L, a beam generator 15R and a beam generator 15C. For example, the signal divider 150 outputs, to the beam generator 15C, a sound signal which is obtained by dividing a sound signal before dividing so as to have a level that is 0.5 times as large as a level of the sound signal before dividing. Further, the signal divider 150 outputs, to each of the beam generator 15R and the beam generator 15L, a sound signal which is obtained by dividing the sound signal before dividing so as to have a level that is 0.25 times as large as the level of the sound signal before dividing.

The beam generator 15L duplicates a sound signal inputted thereto as many as the speaker units of the array speaker, and imparts predetermined delay times to the duplicated sound signals based on directions of sound beams set in advance, respectively. The sound signals thus delayed are outputted to the array speaker 2A (speaker units 21 to 28) and emitted as sound beams, respectively.

In the beam generator 15L, the delay amounts are set so that the sound beams are emitted to predetermined directions, respectively. The direction of each of the sound beams is set in a manner that the each sound beam is reflected by the left side wall of the bar speaker 4A and reaches a viewer.

The beam generator 15R performs a signal processing in the similar manner as the beam generator 15L so that each of sound beams is reflected by the right side wall of the bar speaker 4A.

The beam generator 15C performs a signal processing in a manner that a sound beam directly reaches a viewer positioned in front of the bar speaker 4A.

Sound wave of the sound beam thus emitted spreads in the height direction upon colliding with the wall. Thus, a sound image is felt to locate at a higher position than the array speaker 2A.

As described above, the bar speaker 4A emits sound in a manner that a sound signal of a center channel containing many human voices also reaches a viewer from the left and right sides of the bar speaker 4A. As a result, a viewer feels that sound is heard from the higher position.

Further, the bar speaker 4A sends sound to a viewer not only from the left and right side of the viewer but also directly from the front side. Sound directly reaching a viewer does not cause change of sound quality resulted from the reflection from the walls.

Incidentally, the array speaker 2A is not limited to one having eight speaker units but may be one capable of outputting sound beams to the left and right sides of the bar speaker 4A.

Next, FIG. 3C is a block diagram showing a part of a configuration for performing a signal processing of a bar speaker 4B according to a modified example 1. As shown in FIG. 3C, the bar speaker 4B includes a BPF 151L between the signal divider 150 and the beam generator 15L. The bar speaker 4B further includes a BPF 151R between the signal divider 150 and the beam generator 15R.

In a configuration of outputting a sound beam to the left and right sides and the front side (center channel) of the speaker, depending on environment within a room, sound beams outputted to the left and right sides reach a viewing position later than a sound beam outputted to the front side, and the sound beams thus reached later may be heard as an echo. Thus, in this modified example, a band pass filter for reducing the echo effect is provided at a front stage of each of the beam generator 15L and the beam generator 15R.

Each of the BPF 151L and the BPF 151R is a band pass filter in which cutoff frequency is set so as to extract a frequency band which is equal to or higher than the second formant frequencies of the vowels and other than a frequency band of the vowels.

Each of the BPF 151L and the BPF 151R removes the frequency band of the vowels from a sound signal passed through the HPF 11. The sound signal, from which the frequency band of the vowels is removed, is outputted to each of the beam generator 15L and the beam generator 15R. By so doing, the frequency band of the vowels is removed from each of sound beams outputted to the left and right sides of the bar speaker 4B. As a result, the echo effect on a viewer can be reduced even in a case where a sound beam outputted from the bar speaker 4B is reflected by the wall and reaches a viewing position later than a sound beam outputted to the front side.

Alternatively, the bar speaker 4B may be configured to have low pass filters. In this case, each of the low pass filters is set to have a cutoff frequency so that a harsh high-frequency sound is removed from an inputted sound signal.

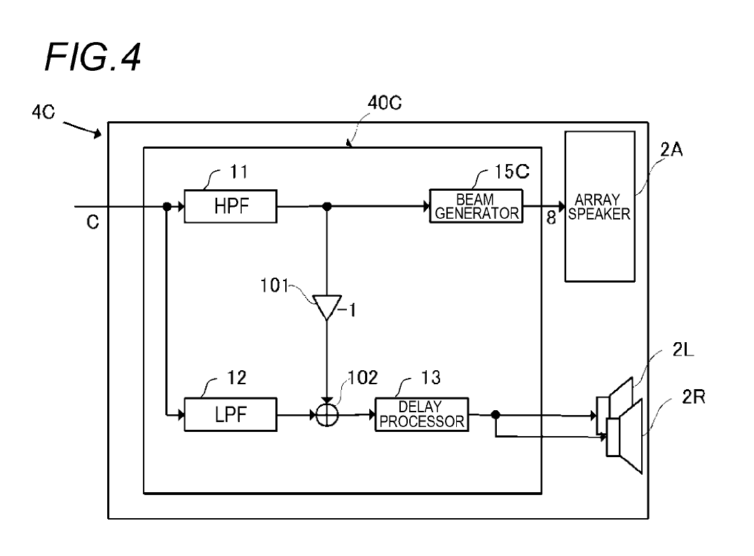

Next, FIG. 4 is a block diagram showing a configuration of a signal processor 40C of a bar speaker 4C according to a modified example 2. The configuration of the signal processor 40C differs from the configuration of the signal processor 40 of the bar speaker 4A in a point of including an opposite-phase generator 101, an adder 102 and the beam generator 15C and further in a point of not including any of the signal divider 150, the beam generator 15L and the beam generator 15R.

A sound signal passed through the HPF 11 is outputted to the beam generator 15C and the opposite-phase generator 101.

The beam generator 15C performs a signal processing in a manner that a sound beam reflected by the walls is not outputted from the array speaker 2A and a sound beam directly reaches a viewer positioned in front of the bar speaker 4C.

The opposite-phase generator 101 inverts a phase of an inputted sound signal and outputs to the adder 102. The sound signal of high-frequency components thus inverted is added to a sound signal of low-frequency components by the adder 102. The sound signal thus added is delayed and emitted from the woofer 2L and the woofer 2R as sound.

The sound beam outputted from the array speaker 2A is weakened in its directivity by the opposite-phase sounds outputted from the woofer 2L and the woofer 2R. As a result, a sound image of the sound beam becomes dim. As described above, the bar speaker 4C unlikely localizes a sound image in the direction of the array speaker 2A and hence can maintain the raising effect of a sound image.

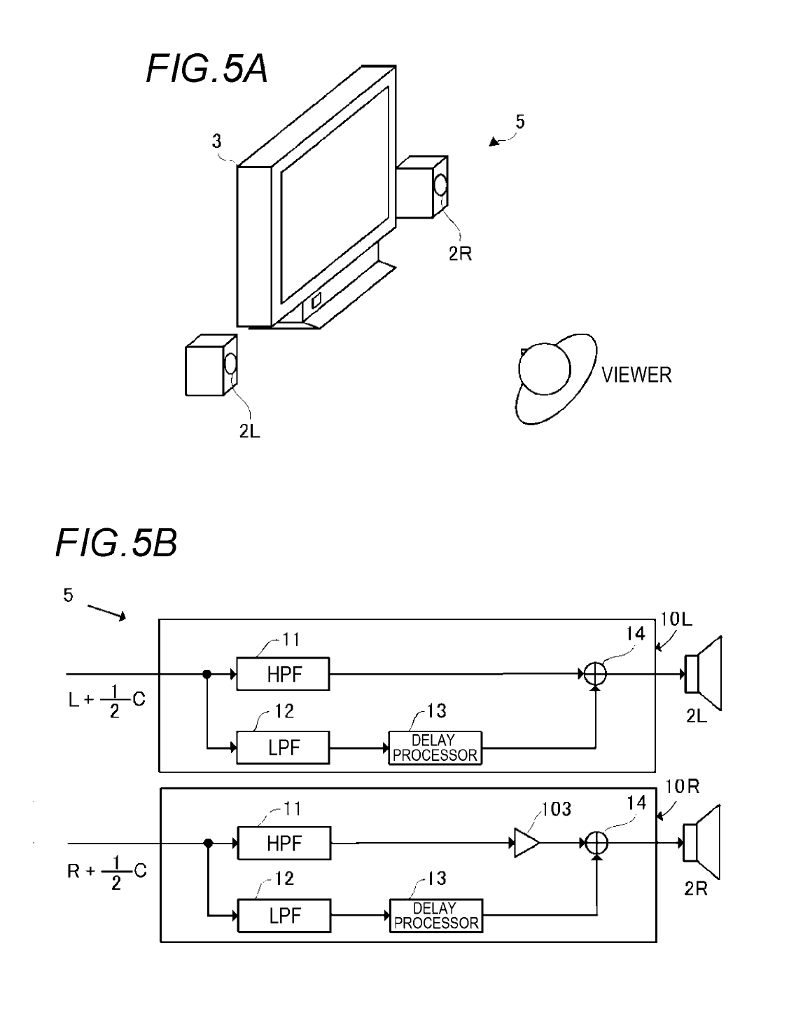

Next, FIG. 5A is a diagram showing install environment of a stereo speaker set 5. FIG. 5B is a block diagram showing a signal processor 10L and a signal processor 10R of the stereo speaker set 5.

The stereo speaker set 5 includes the woofer 2L and the woofer 2R as separate units. As shown in FIG. 5A, the woofer 2L is installed on the left side of the television when seen from a viewer and the woofer 2R is installed on the right side of the television when seen from a viewer. Each of the woofer 2L and the woofer 2R is installed at a lower position than the center position of the display region of the television 3.

The stereo speaker set 5 thus configured outputs sound of a center channel to be outputted from the center speaker, from the woofer 2L and the woofer 2R. More specifically, the stereo speaker set 5 equally divides a sound signal of a center channel and then synthesizes the sound signals thus divided with a sound signal of an L channel and a sound signal of an R channel, respectively.

The sound signal of the L channel synthesized with the sound signal of the center channel is inputted to the signal processor 10L. The sound signal of the R channel synthesized with the sound signal of the center channel is inputted to the signal processor 10R.

As shown in FIG. 5B, the signal processor 10L differs from the signal processor 10 in a point that the sound signal of the L channel synthesized with the sound signal of the center channel is inputted and in a point that the sound signal is outputted to the woofer 2L.

The signal processor 10R differs from the signal processor 10 in a point that the sound signal of the R channel synthesized with the sound signal of the center channel is inputted, in a point that the sound signal is outputted to the woofer 2R and in a point that an opposite-phase generator 103 is provided. The signal processor 10R inverts a phase of sound of high-frequency components outputted from the HPF 11.

More specifically, in the signal processor 10R, a sound signal outputted from the HPF 11 is inputted to the opposite-phase generator 103. The opposite-phase generator 103 inverts a phase of the inputted sound signal of high-frequency components and outputs to the adder 14.

According to this configuration, the stereo speaker set 5 outputs sound of a center channel in the following manner. A phase of sound of high-frequency components outputted from the woofer 2R is opposite to a phase of sound of high-frequency components outputted from the woofer 2L. Human beings have perceiving characteristics that a sound image is spread in a left-right direction when they listen to sounds of opposite phases from left and right directions respectively even if the sounds are the same.

According to this characteristics, a sound image perceived at a higher position than the positions of the woofer 2L and the woofer 2R spreads in the left-right direction, and hence is more likely made conscious by human beings. As a result, the stereo speaker set 5 can enhance the effect of perception that a sound image exists at the higher position.

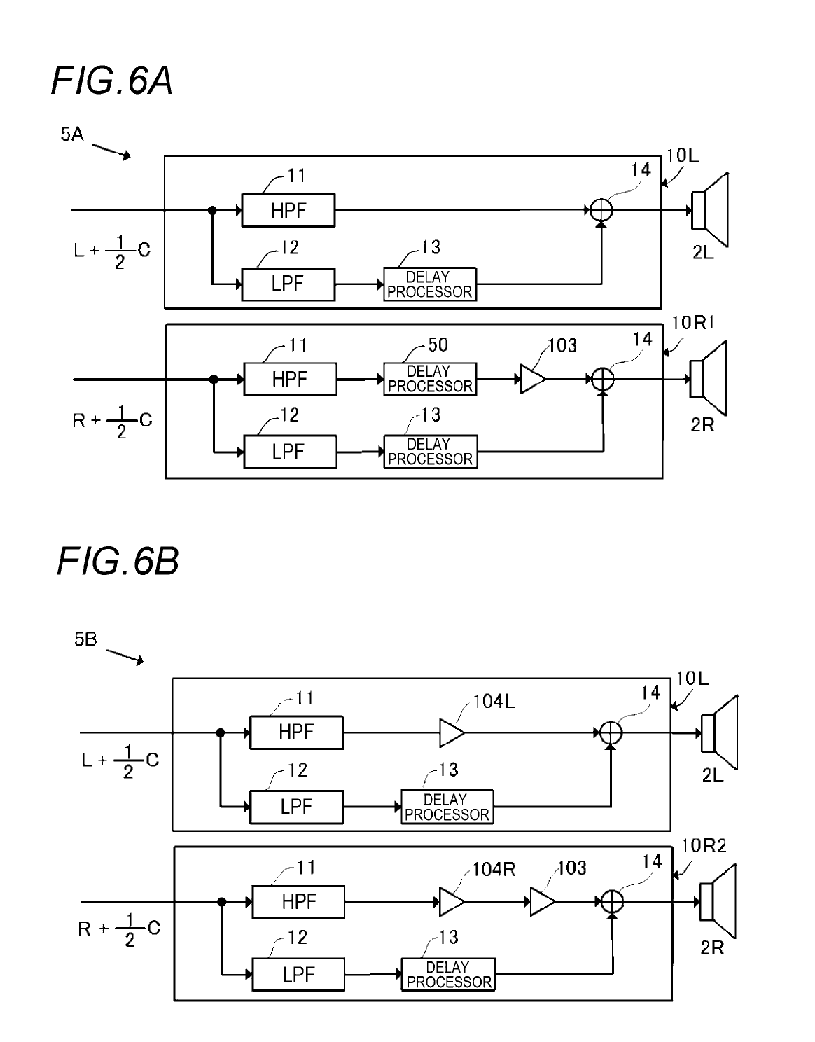

Next, a stereo speaker set 5A according to a modified example of the stereo speaker set 5 will be explained with reference to FIG. 6A. FIG. 6A is a block diagram showing the signal processor 10L and a signal processor 10R1 of the stereo speaker set 5A.

The signal processor 10R1 differs from the signal processor 10R in a point that a delay processor 50 is provided between the HPF 11 and the opposite-phase generator 103. Incidentally, the layout of the delay processor 50 and the opposite-phase generator 103 may be exchanged.

The delay processor 50 delays a sound signal by a time period (1 ms, for example) shorter than a delay time of sound of low-frequency components at the delay processor 13. In other words, the delay processor 50 delays sound of high-frequency components within a range that the sound of high-frequency components is outputted earlier than the sound of low-frequency components to thereby not degrade the effect of perception that a sound image exists at the higher position than the position of the woofer 2R.

In this respect, human beings have characteristics that, in a case where a sound image spreads in a left-right direction, they perceive that a sound image exists on a dominant ear side. Thus, a sound image of high-frequency components of a center channel may be perceived to be deviated, for example, on the right ear side when the sound image is merely spread in a left-right direction.

In view of this, the stereo speaker set 5A utilizes the Haas effect in order to return, to the left side, the sound image of high-frequency components deviated on the right ear side. That is, the stereo speaker set 5A outputs sound of high-frequency components in a manner that the delay processor 50 delays a sound signal of an R channel with respect to a sound signal of an L channel. By so doing, sound of high-frequency components of the center channel contained in the L channel is outputted earlier by, for example, 1 ms than sound of high-frequency components of the center channel contained in the R channel. As a result, a sound image deviated on the right ear side is returned to the left side and hence returns to the center position of the display region of the television 3.

Of course, for a viewer whose dominant ear is the left ear, the stereo speaker set 5 may be provided with a set of the delay processor 50 and the opposite-phase generator 103 within the signal processor 10L.

FIG. 6A is the example in which a sound image is returned to the left side using the Haas effect. However, a sound image may be returned to the left side using a difference of a volume between the L channel and the R channel. FIG. 6B is a block diagram showing a signal processor 10L2 and a signal processor 10R2 of a stereo speaker set 5B according to a modified example of the stereo speaker set 5A.

The signal processor 10L2 differs from the signal processor 10L in a point that a level adjuster 104L is provided between the HPF 11 and the adder 14. The signal processor 1082 differs from the signal processor 10R1 in a point that a level adjuster 104R is provided in place of the delay processor 50.

A gain of the level adjuster 104L is set to be higher than a gain of the level adjuster 104R. For example, in the stereo speaker set 5A, a gain of the level adjuster 104L is set to 0.3 and a gain of the level adjuster 104R is set to −0.3. That is, concerning sound of high-frequency components of a center channel, a sound level outputted from the woofer 2L is higher than that of the woofer 2R. Thus, a sound image deviated to the right ear side is returned to the center position of the display region of the television 3.

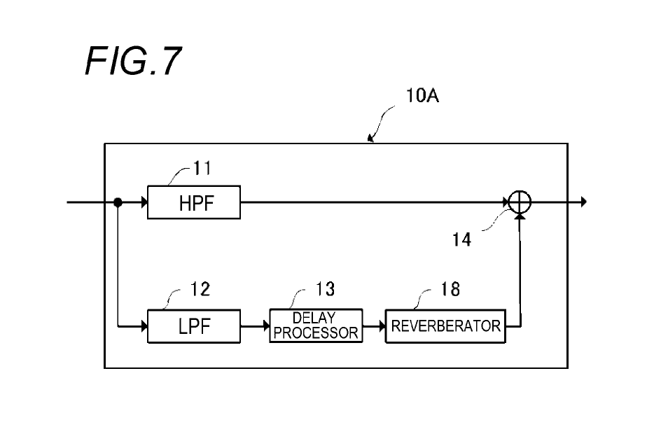

Next, a signal processor 10A according to a modified example 1 of the signal processor 10 will be explained with reference to FIG. 7.

As shown in FIG. 7, the signal processor 10A differs from the signal processor 10 shown in FIG. 1B in a point that a reverberator 18 is provided at a rear stage of the delay processor 13.

A sound signal (low-frequency components) outputted from the delay processor 13 is inputted to the reverberator 18. The reverberator 18 imparts reverberation components to the sound signal thus inputted. The sound signal outputted from the reverberator 18 is emitted from the speaker 2 as sound through the adder 14.

As described above, a center speaker 1A having the signal processor 10A imparts the reverberation components to low-frequency components of the sound signal and emits as sound. As a result, a viewer unlikely perceives a sound image formed by low-frequency components but likely perceives a sound image formed by high-frequency components. Further, in a case where a sound image becomes unclear, a viewer can feel realistic sensation as if sound is emitted from the image screen, due to mental auditory characteristics that a viewer perceives that sound is emitted from the image screen.

The connection position of the reverberator 18 is not limited to the rear stage of the delay processor 13 but may be the front stage of the LPF 12 or between the LPF 12 and the delay processor 13.

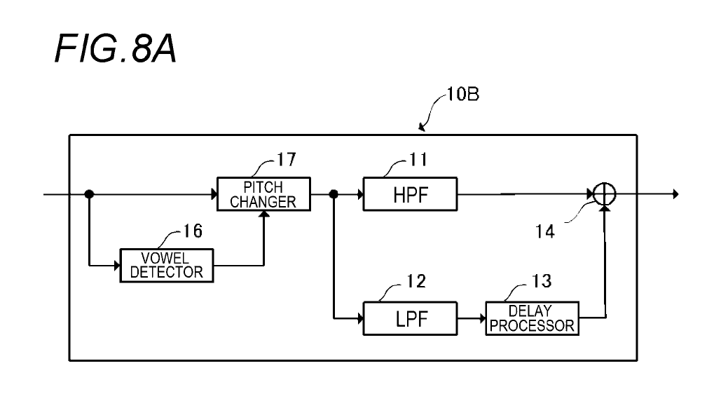

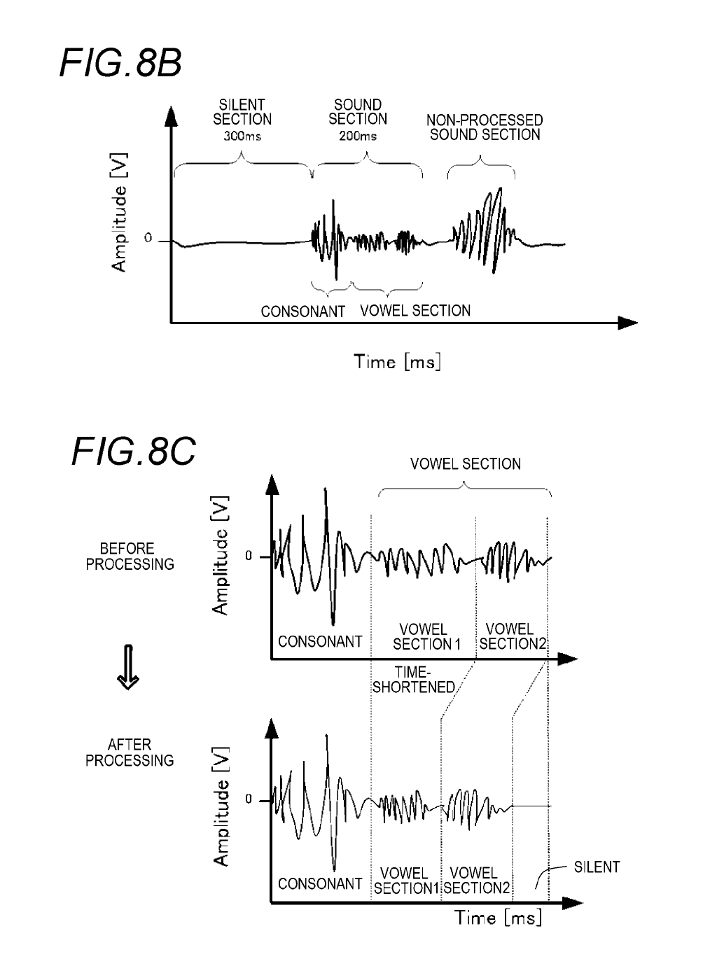

Next, a signal processor 10B according to a modified example 2 of the signal processor 10 will be explained with reference to FIGS. 8A and 8B. FIG. 8A is a block diagram showing the signal processor 10B. FIG. 8B is a schematic diagram showing a sound signal of a speech by a person.

A sound image constituted of sound of high-frequency components is likely perceived when low-frequency components is reduced. Low-frequency components is reduced when a pitch of a sound signal is shortened. However, a viewer feels a sense of incongruity when pitches of all sound signals are changed. Further, a vowel largely influences perception of a sound image than a consonant. Thus, the signal processor 10B changes pitches of only vowels while preventing change of sound quality, thereby enabling a viewer to likely perceive a sound image of sound constituted of high-frequency components.

As shown in FIG. 8A, the signal processor 10B includes a vowel detector 16 and a pitch changer 17.

The vowel detector 16 detects a start portion of a speech by a person from a sound signal having been inputted. The vowel detector 16 detects a sound period of a predetermined length (a time period during which a sound of a predetermined level or more is detected), as a start portion of a speech, after a silent section of a predetermined length (a time period during which a sound of a detectable level is hardly detected). For example, as shown in FIG. 8B, the vowel detector 16 detects a sound period of 200 ms, as a start portion of a speech, after a silent section of 300 ms.

Next, the vowel detector 16 detects a vowel section (a time period during which a vowel is detected) at the start portion of the speech thus detected. For example, as shown in FIG. 8B, the vowel detector 16 detects a predetermined time period, as a vowel section, after a predetermined time period (a consonant section) from an initiation of the start portion (sound section) of a speech.

The vowel detector 16 outputs a detection result of a vowel (a time period of the vowel section) to the pitch changer 17.

The pitch changer 17 changes the pitch so as to shorten the pitch of a sound signal only during the consonant section, using the time period of the vowel section sent from the vowel detector 16. As a result, low-frequency components of a sound signal reduce.

The change of the pitch is performed by shortening a part of a vowel section. FIG. 8C is a diagram showing an example of shortening a part of a vowel section.

In FIG. 8C, a vowel section is constituted of, for example, a vowel section 1 and a vowel section 2. In this case, the pitch changer 17 shortens the vowel section 1. Further, the pitch changer 17 moves the vowel section 2 so as to continue to the vowel section 1 thus shortened. Lastly, the pitch changer 17 inserts a silent section, time period of which is equal to a shortened time period of the vowel section 1, after the vowel section 2.

As described above, as low-frequency components of a vowel reduces by shortening the pitch of a sound signal, the high-frequency components increases as compared with the low-frequency components. Thus, a viewer likely feels that sound is heard from a higher position than the position of a center speaker 1B having the signal processor 10B.

Incidentally, the installation position of each of the vowel detector 16 and the pitch changer 17 is not limited to the front stage of the LPF 12 but may be the rear stage of the LPF 12.

Further, the vowel detector 16 does not detect a sound period other than a start portion of a speech. For example, in FIG. 8B, the vowel detector 16 does not detect a sound period continuing after the sound period of 200 ms detected as the start portion of the speech. Thus, the signal processor 10B can suppress a change of sound quality to the minimum by limiting a section during which a pitch is changed.

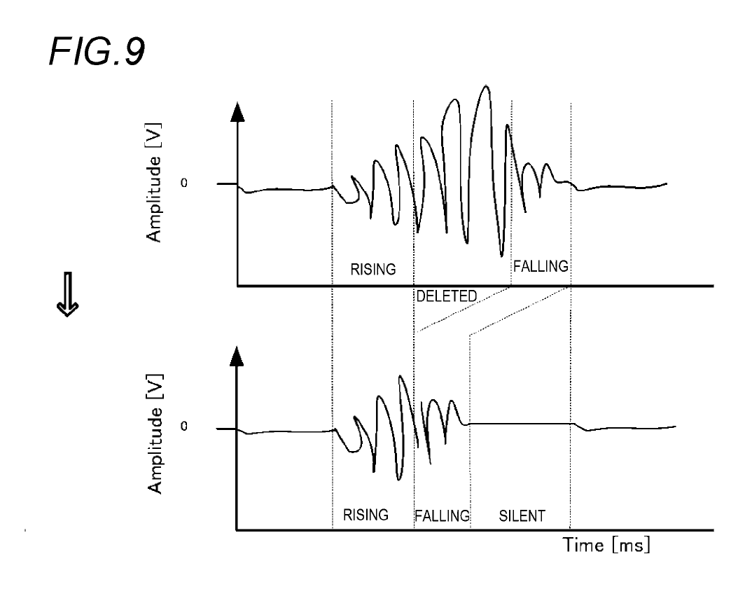

Another example of the pitch change will be explained. As shown in FIG. 9, when a consonant section starting after a predetermined silent section is detected, a pitch changer 17A deletes a sound signal during a certain section between a rising section and a falling section of the sound signal within the consonant section, whilst remaining the rising section and the falling section of a predetermined time period in total. Then, the pitch changer 17A couples the rising section with the falling section of the sound signal to thereby shorten the consonant section. Further, the pitch changer 17A inserts a silent section, time period of which is equal to that of the deleted section of the sound signal, after the falling section of the sound signal.

As described above, the pitch changer 17A shortens a consonant section containing much high-frequency components. As a result, as harsh high-frequency components are reduced, a viewer can perform listening more naturally.

Next, emphasizing of a vowel portion will be explained. Of human voices, the second formant frequencies of vowels largely influence the perception of a sound image. Thus, the signal processor 10 emphasizes a signal level in the vicinity of the second formant frequency of a vowel to thereby further emphasize the perception of a sound image of sound.

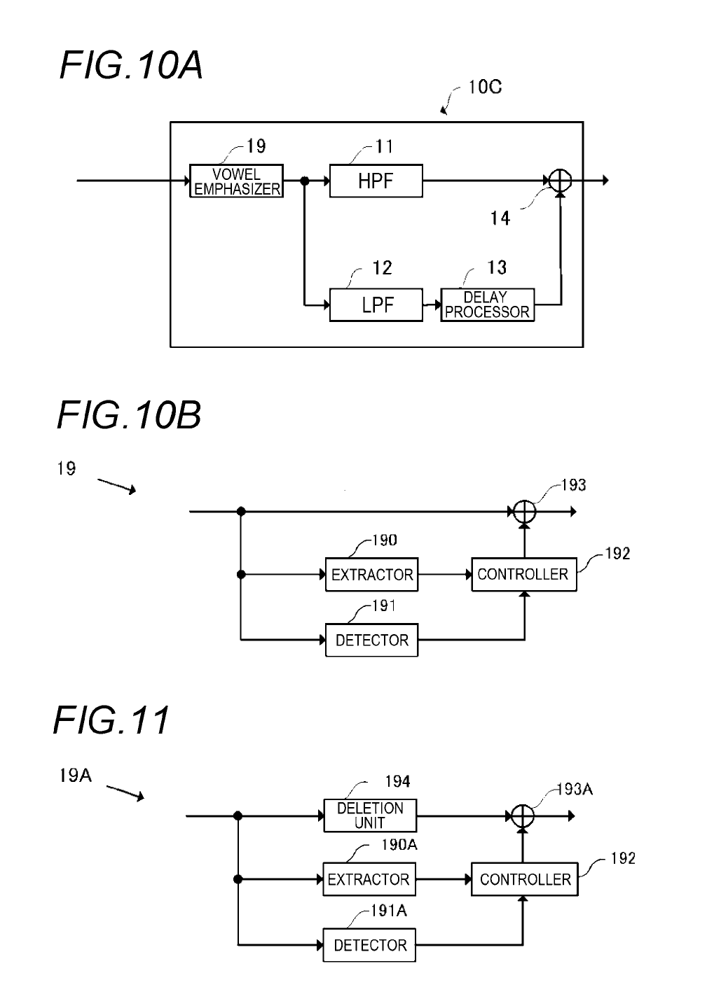

FIG. 10A is a block diagram showing a signal processor 10C according to a modified example 3 of the signal processor 10. As shown in FIG. 10A, the signal processor 10C includes a vowel emphasizer 19 for emphasizing a vowel, provided at a front stage of each of the HPF 11 and the LPF 12.

FIG. 10B is a block diagram showing a configuration of the vowel emphasizer 19. The vowel emphasizer 19 is constituted of an extractor 190, a detector 191, a controller 192 and an adder 193.

A sound signal is inputted to the vowel emphasizer 19. That is, a sound signal is inputted to each of the extractor 190 and the detector 191.

The extractor 190 is a band pass filter which extracts a sound single of a predetermined first frequency band (1,000 Hz to 10,000 Hz, for example). The first frequency band is set to contain the second formant frequencies of respective vowels.

A sound signal inputted to the extractor 190 is outputted as a sound signal of the first frequency band thus extracted. The sound signal of the extracted first frequency band is inputted to the controller 192.

The detector 191 includes a band pass filter which extracts a sound single of a predetermined second frequency band (300 Hz to 1,000 Hz, for example). The second frequency band is set to contain the first formant frequencies of respective vowels.

The detector 191 detects that a vowel is contained when a level of the second frequency band of a sound signal is a predetermined level or more. The detector 191 outputs a detection result (presence or absence of a vowel) to the controller 192.

When the detector 191 detects a vowel, the controller 192 outputs, to the adder 193, the sound signal outputted from the extractor 190. When the controller 192 does not determine that the detector 191 detects a vowel, the controller does not output the sound signal to the adder 193. Incidentally, the controller 192 may change a level of the sound signal outputted from the extractor 190 and then output to the adder 193.

The adder 193 adds a sound signal outputted from the controller 192 with a sound signal inputted to the vowel emphasizer 19 and outputs to a rear stage.

As described above, when the vowel emphasizer 19 detects a vowel from a sound signal, the vowel emphasizer adds a sound signal of the predetermined second frequency band. That is, the vowel emphasizer 19 amplifiers a level of the predetermined second frequency band with respect to a sound signal to thereby emphasize the vowel portion.

A sound signal, in which a vowel is emphasized, is outputted to the HPF 11 and the LPF 12 from the vowel emphasizer 19. Then, the sound signal passes through the HPF 11. That is, the high-frequency components of a vowel thus emphasized is emitted as sound from the speaker 2 earlier than low-frequency components.

As a result, a center speaker 1C having the signal processor 10C can further emphasize the effect that a sound image is perceived at a higher position, by increasing a sound level in the vicinity of the second formant frequencies of vowels which likely forms a sound image.

Incidentally, the extractor 190 may be configured to include plural filters arranged in parallel so as to extract not only single frequency band but also plural different frequency bands so that a level of a sound signal outputted from each of these filters may be changed. In this case, the vowel emphasizer 19 can increase a level of a predetermined frequency band as desired, and hence can correct a sound signal so as to have frequency characteristics likely emphasizing a sound image.

The signal processor 10C may include a consonant attenuator 19A for weakening consonants (in particular, a sibilant starting with S) in place of the vowel emphasizer 19. FIG. 11 is a block diagram relating to the consonant attenuator 19A.

The consonant attenuator 19A includes an extractor 190A, a detector 191A, an adder 193A and a deletion unit 194.

The extractor 190A is a band pass filter which is set so as to contain frequency band of consonants (3,000 Hz to 7,000 Hz, for example).

The detector 191A includes a band pass filter which is set so as to contain the frequency band of consonants. The detector 191A determines that a sound signal contains a consonant when a level of the sound signal having been filtered is a predetermined value or more.

The deletion unit 194 is a band elimination filter which eliminates a predetermined frequency band. The predetermined frequency band of the deletion unit 194 is set so as to be same as the frequency band (3,000 Hz to 7,000 Hz in the aforesaid example) set in the extractor 190A.

A sound signal inputted to the deletion unit 194 is outputted as a sound signal from which the predetermined frequency band is eliminated. The sound signal, from which the predetermined frequency band is thus eliminated, is outputted to the adder 193A.

A sound signal is also inputted to the extractor 190A. This sound signal is outputted as a sound signal of the predetermined frequency band. This sound signal of the predetermined frequency band is inputted to the controller 192.

A sound signal is also inputted to the detector 191A. The detector 191A outputs a detection result (presence or absence of a consonant in a sound signal) to the controller 192.

When the detector 191 does not detect a consonant, the controller 192 outputs the sound signal outputted from the extractor 190A to the adder 193A. When the detector 191 detects a consonant, the controller 192 does not outputs the sound signal to the adder 193A.

The adder 193A adds a sound signal outputted from the deletion unit 194 with a sound signal outputted from the controller 192 and outputs to a rear stage. When a consonant is contained in a sound signal, the adder 193A outputs a sound signal outputted from the deletion unit 194 to the rear stage. When a consonant is not contained in a sound signal (a vowel or sound other than human voice), the adder 193A adds a sound signal from the deletion unit 194 with a sound signal from the controller 192 and outputs to the rear stage. That is, when a consonant is not contained in a sound signal, the adder 193A outputs a sound signal, which is the same as a sound signal inputted to the consonant attenuator 19A, to the rear stage.

As described above, when a consonant is detected, the consonant attenuator 19A eliminates a part of the frequency band of a sound signal and outputs to the rear stage. Thus, as the part of the frequency band of sound is weakened, a sound volume of the consonant (in particular, a sibilant starting with S) felt to be harsh for a viewer becomes small. As a result, a viewer can listen to sound naturally.

Incidentally, the signal processor 10C may include both the vowel emphasizer 19 and the consonant attenuator 19A. In this case, the emphasizing of a vowel and the attenuation of a consonant is performed simultaneously. As a result, a difference between a level of a vowel and a level of a consonant becomes large. Thus, an effect of the emphasizing of a vowel portion and the attenuation of a consonant becomes larger.

The present application is based on Japanese Patent Application No. 2013-015487 filed on Jan. 30, 2013, the contents of which are incorporated herein by reference.

### INDUSTRIAL APPLICABILITY

The present invention is advantageous in a point that a sound image with a feeling of realistic sensation, as if sound is emitted from the image screen of the image display device, can be formed.

### REFERENCE SIGNS LIST

1 center speaker
2 speaker
2A array speaker
21 to 28 speaker unit
2L, 2R woofer
3 television
4 bar speaker
10 signal processor
40 signal processor
11 HPF
12 LPF
13 delay processor
14, 102 adder
101 opposite-phase generator
15C, 15R, 15L beam generator
150 signal divider
151L, 151R BPF
16 vowel detector
17 pitch changer
18 reverberator
19 vowel emphasizer
19A consonant attenuator
190 extractor
191 detector
192 controller
193 adder
194 deletion unit

1. A sound-emitting device comprising:
a high-frequency extractor, adapted to accept input of a sound signal, extract high-frequency components of sound and output a high-frequency sound signal;
a low-frequency extractor, adapted to accept input of the sound signal, extract low-frequency components of sound and output a low-frequency sound signal;
a delay processor, adapted to delay low-frequency components of the low-frequency sound signal within a time range not causing an echo, relative to the high-frequency sound signal, to thereby output a delayed low-frequency sound signal; and
a sound emitter, adapted to emit sound based on the high-frequency sound signal and the delayed low-frequency sound signal.

2. The sound-emitting device according to claim 1, further comprising
an adder, adapted to add the delayed low-frequency sound signal with the high-frequency sound signal to output an added sound signal, wherein
the sound emitter emits sound based on the added sound signal.

3. The sound-emitting device according to claim 1, wherein
cutoff frequencies of the high-frequency extractor and the low-frequency extractor are set to frequencies in a vicinity of formant frequencies of vowels, respectively.

4. The sound-emitting device according to claim 1, further comprising
a pitch changer which is provided at a front or rear stage of the low-frequency extractor and is adapted to change a pitch of the inputted sound signal.

5. The sound-emitting device according to claim 4, wherein
the pitch changer changes a pitch of a sound signal of a vowel section of the inputted sound signal.

6. The sound-emitting device according to claim 1, further comprising
a reverberation imparting unit which is provided at a front or rear stage of the low-frequency extractor and is adapted to impart reverberation components to the inputted sound signal.

7. A sound-emitting method comprising:
extracting high-frequency components of an inputted sound signal and outputting a high-frequency sound signal;
extracting low-frequency components of the sound signal and outputting a low-frequency sound signal;
delaying low-frequency components of the low-frequency sound signal within a time range not causing an echo relative to the high-frequency sound signal and outputting a delayed low-frequency sound signal; and
emitting sound based on the high-frequency sound signal and the delayed low-frequency sound signal.
